(19) United States
(12) Patent Application Publication
(10) Pub. No.: US 2026/0238012 A1
(43) Pub. Date: Aug. 13, 2026

(54) METHOD OF SUPPLYING ENERGY AND APPARATUS FOR PERFORMING THE SAME

(71) Applicant: ELECTRONICS AND TELECOMMUNICATIONS RESEARCH INSTITUTE, Daejeon (KR)

(72) Inventors: Sewan HEO, Daejeon (KR); Tai-yeon KU, Daejeon (KR); Wan Ki PARK, Daejeon (KR)

(21) Appl. No.: 19/404,448

(22) Filed: Dec. 1, 2025

(30) Foreign Application Priority Data
Feb. 7, 2025 (KR) 10-2025-0015704

(51) Int. Cl. H02J 3/32; H02J 3/46

(52) U.S. Cl. CPC H02J 3/32; H02J 3/46

(57) ABSTRACT

A method of supplying energy to an energy using facility includes determining one from a plurality of operation modes of the operation apparatus, based on energy demand of the energy using facility, a maximum output of a generator, and an amount of energy stored in the energy storage system, and controlling the plurality of generators and the energy storage system, based on the determined operation mode, wherein the plurality of operation modes includes a first operation mode to control one of the plurality of generators to operate based on the energy demand, a second operation mode to control two or more of the plurality of generators to operate based on the energy demand, and a third operation mode to control one of the plurality of generators to operate based on the maximum output and control the energy storage system to operate based on the energy demand.

### CROSS-REFERENCE TO RELATED APPLICATION

This application claims the benefit of Korean Patent Application No. 10-2025-0015704 filed on February 7, 2025, in the Korean Intellectual Property Office, the entire disclosure of which is incorporated herein by reference for all purposes.

### BACKGROUND

### Field of the Invention

The following description relates to a method of supplying energy and an apparatus for performing the same.

### Description of the Related Art

An energy supply system may adjust the amount of power generated according to energy demand to stably supply energy to an energy using facility. When the energy demand increases, the energy supply system may compensate for energy shortage by operating an additional generator or using an auxiliary energy source (e.g., an energy storage device or auxiliary generator).

When the operating time of the generator is insufficient or the energy demand rapidly changes, it may be difficult to maintain the stability of energy supply. In a typical energy supply system, a plurality of generators may be inefficiently operated or an auxiliary energy source may be underutilized to hedge against excessive demand increases.

The above description has been possessed or acquired by the inventor(s) in the course of conceiving the present disclosure and is not necessarily an art publicly known before the present application is filed.

### SUMMARY

An embodiment may provide a method of supplying energy to an energy using facility.

An embodiment may control operations of a generator and an energy storage system based on an operation mode of an integrated operation system.

An embodiment may effectively respond to a change in energy demand of an energy using facility by controlling operations of a generator and an energy storage system.

However, the technical aspects are not limited to the aforementioned aspects, and other technical aspects may be present.

According to an embodiment, a method of operating an operation apparatus for controlling energy supply to an energy using facility using a plurality of generators and an energy storage system, the method includes determining one from a plurality of operation modes of the operation apparatus, based on energy demand of the energy using facility, a maximum output of a generator, and an amount of energy stored in the energy storage system, and controlling the plurality of generators and the energy storage system, based on the determined operation mode, wherein the plurality of operation modes includes a first operation mode to control one of the plurality of generators to operate based on the energy demand, a second operation mode to control two or more of the plurality of generators to operate based on the energy demand, and a third operation mode to control one of the plurality of generators to operate based on the maximum output and control the energy storage system to operate based on the energy demand.

According to an embodiment, the determining includes determining one from the plurality of operation modes by comparing the maximum output, the amount of energy stored, and the energy demand.

According to an embodiment, the determining includes, when the energy demand is greater than or equal to the maximum output, determining the one to be the third operation mode.

According to an embodiment, the determining includes, when the energy demand is less than the maximum output, determining the one to be the first operation mode.

According to an embodiment, the determining includes, when the energy demand is greater than a sum of the maximum output and the amount of energy stored, determining the one to be the second operation mode.

According to an embodiment, the method further includes, while controlling the plurality of generators and the energy storage system in the third operation mode, when the energy demand exceeds a sum of the maximum output and the amount of energy stored, switching the third operation mode to the second operation mode.

According to an embodiment, in the second operation mode, the two or more generators operate in proportion to respective capacities of the two or more generators.

According to an embodiment, an operation apparatus for controlling operations of a plurality of generators and an energy storage system, the operation apparatus includes a processor, and memory storing instructions, wherein the instructions, when executed by the processor, cause the operation apparatus to determine one from a plurality of operation modes of the operation apparatus, based on energy demand of the energy using facility, a maximum output of a generator, and an amount of energy stored in the energy storage system, and control the plurality of generators and the energy storage system, based on the determined operation mode, wherein the plurality of operation modes includes a first operation mode to control one of the plurality of generators to operate based on the energy demand, a second operation mode to control two or more of the plurality of generators to operate based on the energy demand, and a third operation mode to control one of the plurality of generators to operate based on the maximum output and control the energy storage system to operate based on the energy demand.

According to an embodiment, the instructions further cause the operation apparatus to determine one from the plurality of operation modes by comparing the maximum output, the amount of energy stored, and the energy demand.

According to an embodiment, the instructions further cause the operation apparatus to, when the energy demand is greater than or equal to the maximum output, determine the one to be the third operation mode.

According to an embodiment, the instructions further cause the operation apparatus to, when the energy demand is less than the maximum output, determine the one to be the first operation mode.

According to an embodiment, the instructions further cause the operation apparatus to, when the energy demand is greater than a sum of the maximum output and the amount of energy stored, determine the one to be the second operation mode.

According to an embodiment, the instructions further cause the operation apparatus to, while controlling the plurality of generators and the energy storage system in the third operation mode, when the energy demand exceeds a sum of the maximum output and the amount of energy stored, switch the third operation mode to the second operation mode.

According to an embodiment, the instructions further cause the operation apparatus to cause the two or more generators to operate in proportion to respective capacities of the two or more generators, in the second operation mode.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a system for controlling energy supply according to an embodiment;

FIG. 2 is a diagram illustrating an operation device according to an embodiment;

FIG. 3 is a flowchart of a method of controlling energy supply, according to an embodiment;

FIG. 4 is a diagram illustrating operations of a generator and an energy storage system over time according to an embodiment;

FIGS. 5 and 6 are graphs showing operations of a generator and an energy storage system over time according to an embodiment;

FIG. 7 is a flowchart of a method of controlling energy supply, according to an embodiment; and

FIG. 8 is a schematic block diagram of an electronic device according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that if it is described that one component is "connected", "coupled", or "joined" to another component, a third component may be "connected", "coupled", and "joined" between the first and second components, although the first component may be directly connected, coupled, or joined to the second component.

As used herein, the singular form is intended to include the plural forms as well, unless the context clearly indicates otherwise. As used herein, "A or B", "at least one of A and B", "at least one of A or B", "A, B or C", "at least one of A, B and C", and "at least one of A, B, or C," each of which may include any one of the items listed together in the corresponding one of the phrases, or all possible combinations thereof. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

The term "unit" used herein may refer to a software or hardware component, such as an FPGA or an ASIC, and the "unit" performs predefined functions. However, the term "unit" is not limited to software or hardware. The "unit" may be configured to be in an addressable storage medium or configured to operate one or more processors. For example, the "unit" may include components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and "units" may be combined into fewer components and "units" or may be further separated into additional components and "units." Furthermore, the components and "units" may be implemented to operate on one or more central processing units (CPUs) within a device or a security multimedia card. In addition, "unit" may include one or more processors.

Hereinafter, embodiments will be described in detail with reference to the accompanying drawings. When describing the embodiments with reference to the accompanying drawings, like reference numerals refer to like elements and a repeated description related thereto will be omitted.

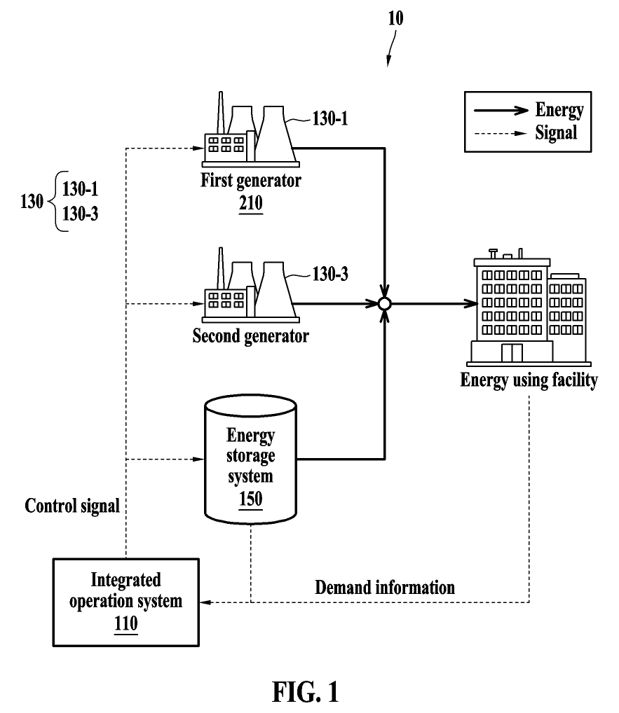

FIG. 1 is a diagram illustrating a system for controlling energy supply according to an embodiment.

Referring to FIG. 1, according to an embodiment, a system 10 for controlling energy supply may include an integrated operation system(or operation apparatus) 110, a generator 130, an energy storage system 150, and an energy using facility. The integrated operation system 110 may transmit a control signal to a first generator 130-1, a second generator 130-3, and the energy storage system 150. The generator 130 may include the first generator 130-1 and the second generator 130-3. The first generator 130-1, the second generator 130-3, and the energy storage system 150 may supply energy to the energy using facility.

The integrated operation system 110 may control operations of the generator 130 (e.g., the first generator 130-1 and/or the second generator 130-3) and the energy storage system 150. For example, the integrated operation system 110 may control operating states of the generator 130 (e.g., the first generator 130-1 and/or the second generator 130-3) and the energy storage system 150 based on a change in energy demand of the energy using facility.

The integrated operation system 110 may control the generator 130 (e.g., the first generator 130-1 and/or the second generator 130-3) and the energy storage system 150 to efficiently operate through the control signal. For example, the integrated operation system 110 may control the generator 130 (e.g., the first generator 130-1 and/or the second generator 130-3) to operate at minimum output during a time window (e.g., night) with low energy demand. The integrated operation system 110 may control the energy storage system 150 to store energy at the time window with low energy demand. The integrated operation system 110 may control the energy storage system 150 to supply stored energy to the energy using facility at a specific time window in which the energy demand rapidly increases.

The integrated operation system 110 may obtain energy demand information from the energy using facility. The integrated operation system 110 may obtain information about the amount of energy stored from the energy storage system 150. The integrated operation system 110 may determine an operation mode of the integrated operation system 110 to be one of a plurality of operation modes (e.g., a first operation mode, a second operation mode, and a third operation mode), based on the energy demand of the energy using facility, the maximum output of the generator (e.g., the first generator 130-1 and/or the second generator 130-3), and the amount of energy stored in the energy storage system 150. The integrated operation system 110 may control a plurality of generators (e.g., the first generator 130-1 and/or the second generator 130-3) and the energy storage system 150 based on the determined operation mode. The integrated operation system 110 may generate a control signal according to the determined operation mode and may transmit the control signal to the generator 130 (e.g., the first generator 130-1 and/or the second generator 130-3) and the energy storage system 150.

The plurality of operation modes of the integrated operation system 110 may include the first operation mode, the second operation mode, and the third operation mode. The first operation mode may be to control one of the plurality of generators (e.g., the first generator 130-1 and/or the second generator 130-3) to operate based on the energy demand of the energy using facility. The second operation mode may be to control two or more of the plurality of generators (e.g., the first generator 130-1 and/or the second generator 130-3) to operate based on the energy demand of the energy using facility. The third operation mode may be to control one of the plurality of generators (e.g., the first generator 130-1 and/or the second generator 130-3) to operate based on the maximum output, and to control the energy storage system 150 to operate based on the energy demand of the energy using facility.

The generator 130 (e.g., the first generator 130-1 and/or the second generator 130-3) may generate energy required for the energy using facility. The generator 130 (e.g., the first generator 130-1 and/or the second generator 130-3) may supply the generated energy to the energy using facility. The generator 130 (e.g., the first generator 130-1 and/or the second generator 130-3) may operate individually or together with the energy storage system 150. The generator 130 (e.g., the first generator 130-1 and/or the second generator 130-3) may be combined heat and power (CHP) generators for simultaneously producing heat and electricity.

The first generator 130-1 and the second generator 130-3 may operate in response to the control signal of the integrated operation system 110. For example, the first generator 130-1 and the second generator 130-3 may individually or simultaneously operate in response to the control signal of the integrated operation system 110.

The energy storage system 150 may supply the stored energy to the energy using facility. The stored energy by the energy storage system 150 may be energy generated by the generator 130 (e.g., the first generator 130-1 and/or the second generator 130-3).

When the energy storage system 150 stores energy, the amount of energy supplied to the energy using facility from the generator 130 (e.g., the first generator 130-1 and/or the second generator 130-3) may decrease. When the energy storage system 150 supplies the stored energy to the energy using facility, the amount of energy supplied to the energy using facility from the generator 130 (e.g., the first generator 130-1 and/or the second generator 130-3) and the energy storage system 150 may increase.

The energy storage system 150 may transmit the information about the amount of energy stored to the integrated operation system 110. The integrated operation system 110 may control the energy storage system 150 based on the information about the amount of energy stored. Accordingly, the integrated operation system 110 may appropriately respond to the energy demand of the energy using facility. For example, the integrated operation system 110 may control the storage and/or usage of energy of the energy storage system 150. The integrated operation system 110 may control the energy storage system 150 to store excess energy of the generator 130 (e.g., the first generator 130-1 and/or the second generator 130-3). The integrated operation system 110 may contribute to reducing the energy cost of the energy using facility by controlling the operation of the energy storage system 150.

When the amount of energy demand exceeds the capacity of one generator (e.g., the first generator 130-1), the integrated operation system 110 may additionally operate the other generator (e.g., the second generator 130-3). When the energy demand rapidly increases, there may not be sufficient time to additionally operate the other generator. Even if there is sufficient time to additionally operate the other generator, when the energy demand slightly exceeds the capacity of one generator, operating two or more generators simultaneously may be inefficient. The integrated operation system 110 may use the energy storage system 150 rather than the other generator to respond to a case in which the energy demand of the energy using facility rapidly changes or slightly exceeds the capacity of one generator.

The integrated operation system 110 may flexibly respond to various energy demand situations by controlling operations of the generator 130 (e.g., the first generator 130-1 and/or the second generator 130-3) and the energy storage system 150. The integrated operation system 110 may maintain the balance between the energy demand of the energy using facility and energy supply to the energy using facility by controlling operations of the generator 130 (e.g., the first generator 130-1 and/or the second generator 130-3) and the energy storage system 150.

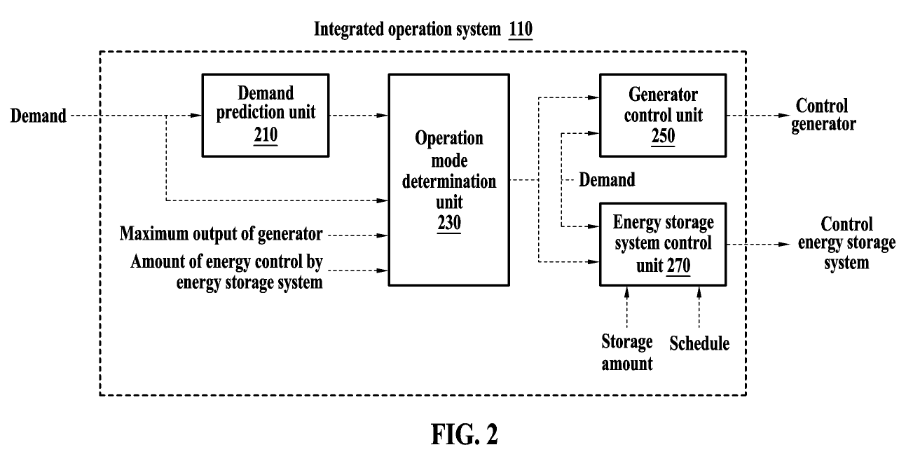

FIG. 2 is a diagram illustrating an operation device according to an embodiment.

In FIG. 2, according to an embodiment, the integrated operation system 110 may include a demand prediction unit 210, an operation mode determination unit 230, a generator control unit 250, and an energy storage system control unit 270.

The demand prediction unit 210 may predict energy demand using energy demand information of an energy using facility. The demand prediction unit 210 may predict the energy demand using an artificial intelligence (AI) technology (e.g., machine learning or deep learning). The predicted energy demand may be energy demand that predicts the demand for the near future at a current time point during the day.

The prediction of energy demand may be an operation required to prepare for operation of a generator. Since the generator needs time to prepare for operation, the integrated operation system 110 may prepare for operation of the generator in advance using the information about energy demand prediction. For example, when the energy demand is predicted to slightly exceed the capacity of one generator, the integrated operation system 110 may prepare to operate an additional generator other than a currently operating generator to respond to the excess demand. The integrated operation system 110 may immediately respond to a change in the energy demand when the energy demand increases by preparing operation of the generator in advance through energy demand prediction.

The operation mode determination unit 230 may determine an operation mode of the integrated operation system 110. The operation mode determination unit 230 may determine an operation mode of the integrated operation system 110 to be one of a plurality of operation modes (e.g., the first operation mode, the second operation mode, and the third operation mode) by comparing the maximum output of the generator 130 (e.g., the first generator 130-1 and/or the second generator 130-3), the amount of energy stored in the energy storage system 150, and the energy demand of the energy using facility. The operation mode may be to determine the operation and output amount of the plurality of generators (e.g., the first generator 130-1 and/or the second generator 130-3), the operation and output amount of the energy storage system 150, and a device for responding (following) to the change in energy demand.

The generator control unit 250 may control operations of the plurality of generators (e.g., the first generator 130-1 and/or the second generator 130-3). The generator control unit 250 may determine operations and output amounts of the plurality of generators (e.g., the first generator 130-1 and/or the second generator 130-3) based on the determined operation mode. The generator control unit 250 may determine a generator to follow the energy demand of the energy using facility from the plurality of generators (e.g., the first generator 130-1 and/or the second generator 130-3). The generator determined to follow the energy demand may adjust the amount of energy output in response to the change in energy demand. For example, the generator determined to follow the energy demand may increase the output amount when the energy demand increases, and may decrease the output amount when the energy demand decreases.

The energy storage system control unit 270 may control an operation of the energy storage system 150. The energy storage system control unit 270 may control an operation of the energy storage system 150 based on the determined operation mode. For example, in the first operation mode and the second operation mode, the energy storage system control unit 270 may control the energy storage system 150 to operate based on a schedule rather than in response to energy demand. When the schedule of the energy storage system 150 is not set, the energy storage system control unit 270 may control the energy storage system 150 to store the energy. In the third operation mode, the energy storage system control unit 270 may control the energy storage system 150 to operate in response to energy demand. For example, in the third operation mode, the energy storage system control unit 270 may control the energy storage system 150 to increase energy supply when the energy demand increases and to decrease energy supply when the energy demand decreases.

The energy storage system control unit 270 may control storage and/or use of energy of the energy storage system 150 based on the amount of energy stored in the energy storage system 150. When there is no stored energy in the energy storage system 150, the energy storage system control unit 270 may control the energy storage system 150 not to use the energy. When the energy is stored in the energy storage system 150 at maximum capacity, the energy storage system control unit 270 may control the energy storage system 150 not to store energy.

The integrated operation system 110 may help supply energy efficiently to the energy using facility by controlling operations of the generator 130 (e.g., the first generator 130-1 and/or the second generator 130-3) and the energy storage system 150 based on the energy demand and the operation mode.

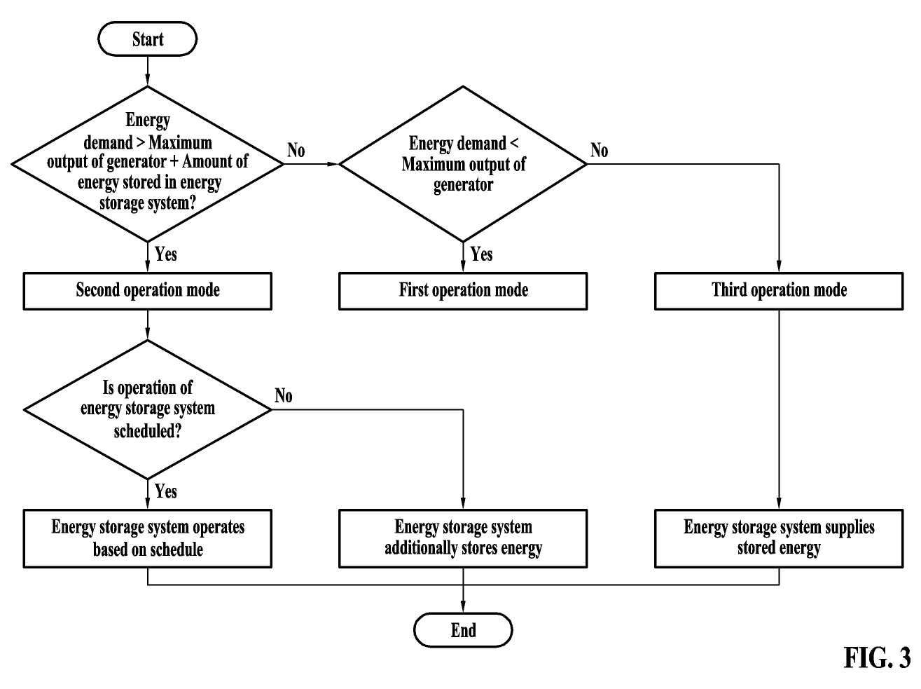

FIG. 3 is a flowchart of a method of controlling energy supply, according to an embodiment.

Referring to FIG. 3, according to an embodiment, the integrated operation system 110 may compare energy demand of the energy using facility to the maximum output of the generator 130 (e.g., the first generator 130-1 and/or the second generator 130-3) and the amount of energy stored in the energy storage system 150. The integrated operation system 110 may determine an operation mode to be one of a plurality of operation modes (e.g., the first operation mode, the second operation mode, and the third operation mode) based on the comparison result.

When the energy demand of the energy using facility is less than the maximum output of one (e.g., the first generator 130-1) of the plurality of generators (e.g., the first generator 130-1 and/or the second generator 130-3), the integrated operation system 110 may determine the operation mode to be the first operation mode.

When the energy demand of the energy using facility is greater than the sum of the maximum output of one (e.g., the first generator 130-1) of the plurality of generators (e.g., the first generator 130-1 and/or the second generator 130-3) and the amount of energy stored in the energy storage system 150, the integrated operation mode 110 may determine the operation mode to be the second operation mode.

When the energy demand of the energy using facility is greater than or equal to the maximum output of one (e.g., the first generator 130-1) of the plurality of generators (e.g., the first generator 130-1 and/or the second generator 130-3), the integrated operation system 110 may determine the operation mode to be the third operation mode.

The integrated operation device 110 may transmit a control signal based on the determined operation mode to the generator 130 (e.g., the first generator 130-1 and/or the second generator 130-3) and the energy storage system 150.

The generator 130 (e.g., the first generator 130-1 and/or the second generator 130-3) may operate in response to the received control signal.

In the first operation mode, one (e.g., the first generator 130-1) of the plurality of generators (e.g., the first generator 130-1 and/or the second generator 130-3) may operate in response to the energy demand of the energy using facility, and the other generators may stop.

In the second operation mode, two or more of the plurality of generators (e.g., the first generator 130-1 and/or the second generator 130-1) may simultaneously respond to the energy demand of the energy using facility. Two or more generators may operate in proportion to their respective capacities. For example, two or more generators may respond to the energy demand of the energy using facility in proportion to their respective capacities. When a generator with a capacity of 60 Gcal/h and a generator with a capacity of 30 Gcal/h are in operation, the output of the generator with the capacity of 60 Gcal/h may be twice the output of the generator with the capacity of 30 Gcal/h.

In the third operation mode, one (e.g., the first generator 130-1) of the plurality of generators (e.g., the first generator 130-1 and/or the second generator 130-3) may operate fixed to the maximum output, and the other generators may be kept on standby, in a state ready for immediate operation.

The energy storage system 150 may operate in response to the received control signal.

In the first operation mode and the second operation mode, when the operation of the energy storage system 150 is scheduled, the energy storage system 150 may operate based on the schedule. When the operation of the energy storage system 150 is not scheduled, the energy storage system 150 may operate to store energy.

In the third operation mode, the energy storage system 150 may supply energy to the energy using facility in response to the energy demand of the energy using facility. In the third operation mode, the energy storage system 150 may supply, together with one of the plurality of generators (e.g., the first generator 130-1 and/or the second generator 130-3), energy to the energy using facility using the stored energy. When the energy storage system 150 has used all stored energy, the energy storage system 150 may stop. In the third operation mode, when the energy storage system 150 has used all stored energy, the integrated operation system 110 may switch the operation mode to the first operation mode or the second operation mode.

While the integrated operation system 110 controls the plurality of generators (e.g., the first generator 130-1 and/or the second generator 130-3) and the energy storage system 150 in the third operation mode, when the energy demand of the energy using facility exceeds the sum of the maximum output of a generator currently in operation among the plurality of generators (e.g., the first generator 130-1 and/or the second generator 130-3) and the amount of energy stored in the energy storage system 150, the integrated operation system 110 may switch the operation mode from the third operation mode to the second operation mode.

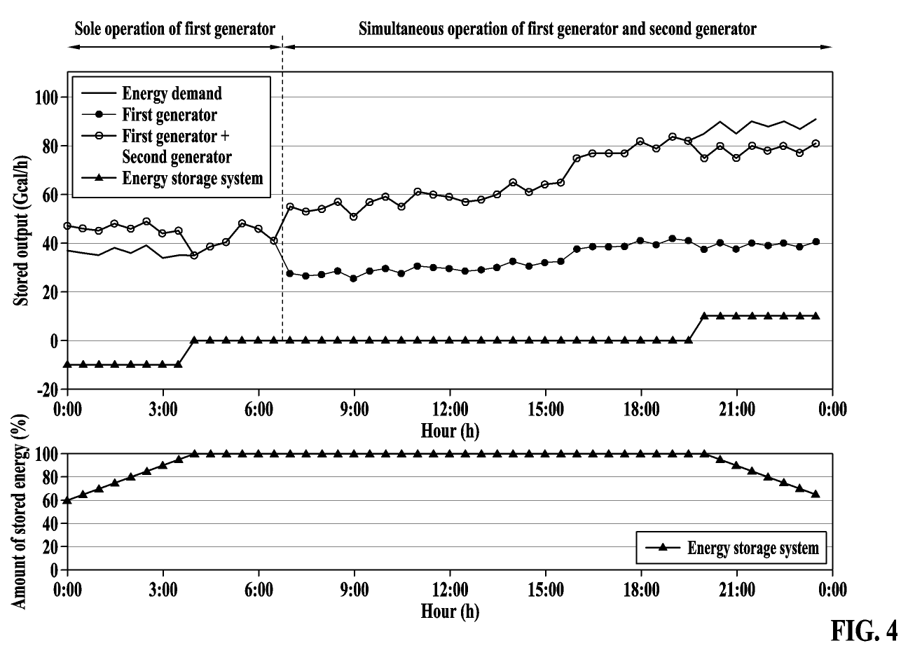

FIG. 4 is a diagram illustrating operations of a generator and an energy storage system over time according to an embodiment.

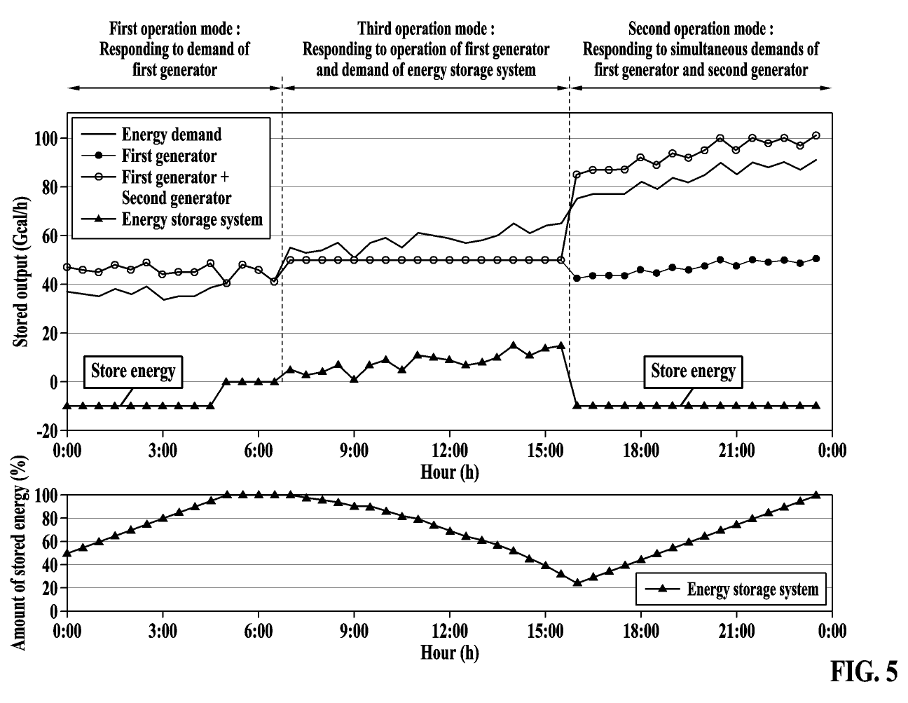

Referring to FIG. 4, according to an embodiment, two generators and the energy storage system 150 may operate without being controlled by the integrated operation system 110. FIG. 5 illustrates a case in which the maximum outputs of two generators (e.g., a first generator and a second generator) are 50 Gcal/h each and the maximum output of the energy storage system 150 is 20 Gcal/h.

From 0:00 to 4:00, the energy storage system 150 may store energy at the output of -10 Gcal/h. The first generator may produce energy corresponding to the sum of energy demand and the amount of energy stored. Since the sum of the energy demand of the energy using facility and the amount of energy stored in the energy storage system 150 does not exceed 50 Gcal/h, which is the maximum output of the first generator, the first generator may solely respond to a change in energy demand while supplying energy corresponding to the sum of the energy demand and the amount of energy stored in the energy storage system 150.

At 4:00, the energy storage system 150 may stop, and the first generator may supply energy to the energy using facility in response to the change in energy demand until 7:00.

At 7:00, since the energy demand of the energy using facility exceeds the maximum output of the first generator, the second generator may start operating to supply energy. The first generator and the second generator may supply energy together in response to the change in energy demand. Since the second generator is already ready to operate before 7:00, the second generator may output immediately in response to an increase in energy demand. When the second generator is not ready to operate due to an unexpected increase in energy demand, the second generator may not supply energy in response to the change in energy demand.

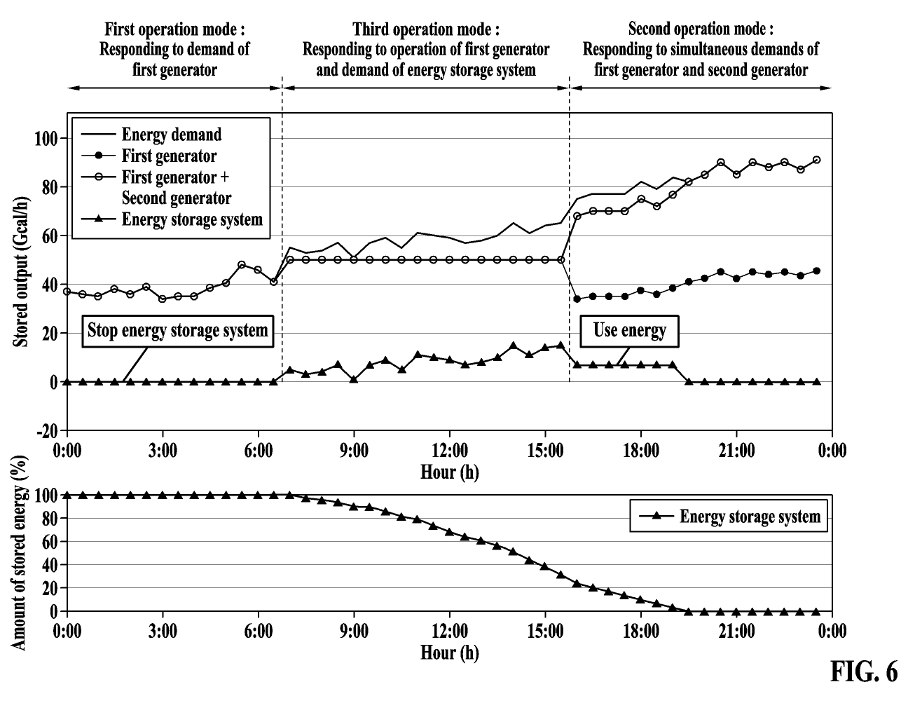

FIGS. 5 and 6 are graphs showing operations of a generator and an energy storage system over time according to an embodiment.

Referring to FIG. 5, according to an embodiment, the maximum outputs of a first generator and a second generator may be 50 Gcal/h each, and the maximum output of the energy storage system 150 may be 20 Gcal/h. FIG. 5 illustrates a situation in which the operation of the energy storage system 150 is not scheduled according to time.

From 0:00 to 7:00, since the energy demand is less than the maximum output (50 Gcal/h) of the first generator, the integrated operation system 110 may determine an operation mode to be the first operation mode. In the first operation mode, the first generator may supply energy to the energy using facility in response to a change in energy demand, and the second generator may stop. The energy storage system 150 may store energy since there is no specified schedule. For example, from 0:00 to 5:00, the energy storage system 150 may store energy at an output of -10 Gcal/h until the amount of energy stored reaches 100%.

At 7:00, since the energy demand exceeds the maximum output of the first generator, the integrated operation system 110 may switch the operation mode to the third operation mode. The first generator may operate at the maximum output (50 Gcal/h), and the second generator may be kept on standby, in a state ready for immediate operation. The energy storage system 150 may respond to the change in energy demand. The energy storage system 150 may supply energy to the energy using facility using the stored energy. Since the energy storage system 150 uses the stored energy in response to the energy demand of the energy using facility, the amount of energy stored in the energy storage system 150 from 7:00to 16:00 may gradually decrease.

In the third operation mode, when the energy demand temporarily decreases within the maximum output of the first generator, the energy storage system 150 may respond to the change in energy demand. For example, the energy storage system 150 may store energy produced in excess of energy demand without using the energy. Since the energy storage system 150 operates while responding to the change in energy demand, the generator 130 (e.g., the first generator 130-1 and/or the second generator 130-3) and the energy storage system 150 may efficiently supply the energy to the energy using facility.

From 16:00, since the energy demand increases to 70 Gcal/h or above, which is the sum of the maximum output of the first generator and the maximum output of the energy storage system 150, the integrated operation system 110 may switch the operation mode to the second operation mode. In the second operation mode, both the first generator and the second generator may operate. For example, the first generator and the second generator may output energy in response to the energy storage of the energy storage system 150 and the energy demand of the energy using facility. Since the energy storage system 150 has no specified schedule in the second operation mode, the energy storage system 150 may store energy at an output of -10 Gcal/h.

Since the two generators have the same capacity, the two generators may output energy at the same rate in response to the energy demand. For example, when the energy demand is 80 Gcal/h, the two generators may supply energy with an output of 40 Gcal/h each. When the energy demand increases or decreases by 10 Gcal/h, the two generators may increase or decrease the output by 5 Gcal/h each.

Since the energy storage system 150 stores energy by 10 Gcal/h from 16:00 to 24:00, the two generators may increase the output by 5 Gcal/h each.

In the third operation mode, only when there is energy stored in the energy storage system 150, the change in energy demand may be met using the energy storage system 150. When the energy storage system 150 has used all stored energy, the integrated operation system 110 may switch the operation mode to the second operation mode, and the energy storage system 150 may stop.

The third operation mode may be used as an intermediate step to switch the operation mode from the first operation mode to the second operation mode. The third operation mode may secure the time required to operate the second generator in response to an increase in energy demand. When the energy demand is slightly greater than the maximum output of the first generator, the third operation mode may prevent inefficient operation of two generators.

When the second generator is ready to operate, the third operation mode may be omitted as needed. When the second generator is ready to operate, the integrated operation system 110 may switch the operation mode from the third operation mode to the second operation mode at an early stage.

Referring to FIG. 6, according to an embodiment, the maximum outputs of the first generator and the second generator may be 50 Gcal/h each, and the maximum output of the energy storage system 150 may be 20 Gcal/h. FIG. 6 illustrates a situation in which the operation of the energy storage system 150 is scheduled according to time.

From 0:00 to 7:00, the integrated operation system 110 may determine the operation mode to be the first operation mode. Based on the determined operation mode, the first generator, the second generator, and the energy storage system 150 may operate. The energy storage system 150 may be scheduled to stop so that the energy storage system 150 may stop without storing or using energy.

From 16:00 to 24:00, since the energy demand increases to 70 Gcal/h or above, which is the sum of the maximum output of the first generator and the maximum output of the energy storage system 150, the integrated operation system 110 may switch the operation mode to the second operation mode. The energy storage system 150 may be scheduled to use energy, thereby using the energy at the output of 10 Gcal/h. Since the energy storage system 150 uses all stored energy at 19:00, the energy storage system 150 may stop regardless of the schedule.

The energy storage system 150 may be scheduled to perform a specific operation at a specific time. For example, when the energy storage system 150 is set to operate in the first operation mode or the second operation mode at the specific time, the energy storage system 150 may operate as scheduled. When the energy storage system 150 is set to the third operation mode, the energy storage system 150 may not operate as scheduled because the energy storage system 150 needs to operate in response to a change in energy demand. When the schedule of the energy storage system 150 in the first operation mode or the second operation mode is not specified, the energy storage system 150 may store energy within a scope of operation based on the determined operation mode.

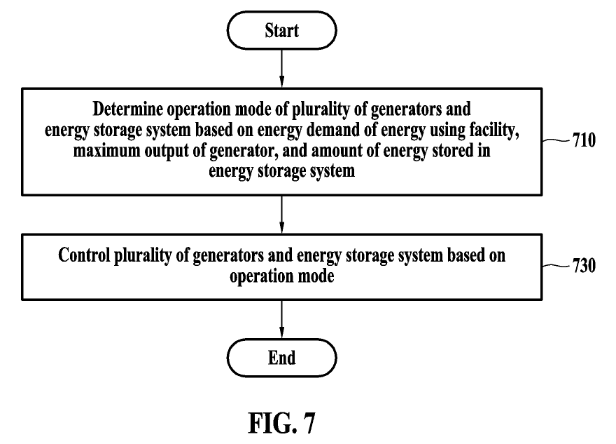

FIG. 7 is a flowchart of a method of controlling energy supply, according to an embodiment.

Referring to FIG. 7, according to an embodiment, operations 710 and 730 may be performed by the integrated operation system 110 of FIG. 1, described with reference to FIGS. 1 to 6.

In operation 710, the integrated operation system 110 may determine an operation mode of the integrated operation system 110 based on energy demand of an energy using facility, the maximum output of a generator (e.g., the generator 130 (e.g., the first generator 130-1 and/or the second generator 130-3) of FIG. 1), and an amount of energy stored in an energy storage system (e.g., the energy storage system 150 of FIG. 1).

In operation 730, the integrated operation system 110 may control operations of the generator 130 (e.g., the first generator 130-1 and/or the second generator 130-3) and the energy storage system 150, based on the determined operation mode.

Operations 710 and 730 may be sequentially performed, but are not limited thereto. For example, two or more operations may be performed in parallel. Operations 710 and 730 may be substantially the same as the method, performed by the integrated operation system 110, of supplying energy to the energy using facility, according to an embodiment described with reference to FIGS. 1 to 6.

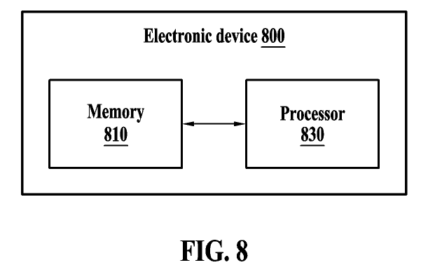

FIG. 8 is a schematic block diagram of an electronic device according to an embodiment.

Referring to FIG. 8, according to an embodiment, an electronic device 800 (e.g., the integrated operation system 110 of FIG. 1) may include a memory 810 and a processor 830.

The memory 810 may store instructions (or programs) executable by the processor 830. For example, the instructions may include instructions for performing an operation of the processor 830 and/or an operation of each component of the processor 830.

The memory 810 may include one or more computer-readable storage media. The memory 810 may include non-volatile storage devices (e.g., magnetic hard disk, optical disk, floppy disk, flash memory, electrically programmable read only memory (EPROM), and electrically erasable PROM (EEPROM)).

The memory 810 may be a non-transitory medium. The term "non-transitory" may indicate that the storage medium is not embodied in a carrier wave or a propagated signal. However, the term "non-transitory" shall not be interpreted that the memory 810 is non-movable.

The processor 830 may process data stored in the memory 810. The processor 830 may execute computer-readable code (e.g., software) stored in the memory 810 and instructions triggered by the processor 830.

The processor 830 may be a data processing device implemented by hardware including a circuit having a physical structure to perform desired operations. For example, the desired operations may include code or instructions included in a program.

For example, the data processing device implemented by hardware may include a microprocessor, a CPU, a processor core, a multi-core processor, a multiprocessor, an application-specific integrated circuit (ASIC), and a field-programmable gate array (FPGA).

The processor 830 may cause the electronic device 800 to perform one or more operations by executing the code and/or instructions stored in the memory 810. The operations performed by the electronic device 800 may be substantially the same as the operations performed by the integrated operation system 110 described with reference to FIGS. 1 to 7. Accordingly, a repeated description is omitted.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of operating an operation apparatus for controlling energy supply to an energy using facility using a plurality of generators and an energy storage system, the method comprising:
determining one from a plurality of operation modes of the operation apparatus, based on energy demand of the energy using facility, a maximum output of a generator, and an amount of energy stored in the energy storage system; and
controlling the plurality of generators and the energy storage system, based on the determined operation mode,
wherein the plurality of operation modes comprises:
a first operation mode to control one of the plurality of generators to operate based on the energy demand;
a second operation mode to control two or more of the plurality of generators to operate based on the energy demand; and
a third operation mode to control one of the plurality of generators to operate based on the maximum output and control the energy storage system to operate based on the energy demand.

2. The method of claim 1, wherein the determining comprises determining one from the plurality of operation modes by comparing the maximum output, the amount of energy stored, and the energy demand.

3. The method of claim 1, wherein the determining comprises, when the energy demand is greater than or equal to the maximum output, determining the one to be the third operation mode.

4. The method of claim 1, wherein the determining comprises, when the energy demand is less than the maximum output, determining the one to be the first operation mode.

5. The method of claim 1, wherein the determining comprises, when the energy demand is greater than a sum of the maximum output and the amount of energy stored, determining the one to be the second operation mode.

6. The method of claim 1, further comprising:
while controlling the plurality of generators and the energy storage system in the third operation mode, when the energy demand exceeds a sum of the maximum output and the amount of energy stored, switching the third operation mode to the second operation mode.

7. The method of claim 1, wherein, in the second operation mode, the two or more generators operate in proportion to respective capacities of the two or more generators.

8. An operation apparatus for controlling operations of a plurality of generators and an energy storage system, the operation apparatus comprising:
a processor; and
memory storing instructions,
wherein the instructions, when executed by the processor, cause the operation apparatus to:
determine one from a plurality of operation modes of the operation apparatus, based on energy demand of the energy using facility, a maximum output of a generator, and an amount of energy stored in the energy storage system, and
control the plurality of generators and the energy storage system, based on the determined operation mode,
wherein the plurality of operation modes comprises:
a first operation mode to control one of the plurality of generators to operate based on the energy demand;
a second operation mode to control two or more of the plurality of generators to operate based on the energy demand; and
a third operation mode to control one of the plurality of generators to operate based on the maximum output and control the energy storage system to operate based on the energy demand.

9. The operation apparatus of claim 8, wherein the instructions further cause the operation apparatus to determine one from the plurality of operation modes by comparing the maximum output, the amount of energy stored, and the energy demand.

10. The operation apparatus of claim 8, wherein the instructions further cause the operation apparatus to, when the energy demand is greater than or equal to the maximum output, determine the one to be the third operation mode.

11. The operation apparatus of claim 8, wherein the instructions further cause the operation apparatus to, when the energy demand is less than the maximum output, determine the one to be the first operation mode.

12. The operation apparatus of claim 8, wherein the instructions further cause the operation apparatus to, when the energy demand is greater than a sum of the maximum output and the amount of energy stored, determine the one to be the second operation mode.

13. The operation apparatus of claim 8, wherein the instructions further cause the operation apparatus to, while controlling the plurality of generators and the energy storage system in the third operation mode, when the energy demand exceeds a sum of the maximum output and the amount of energy stored, switch the third operation mode to the second operation mode.

14. The operation apparatus of claim 8, wherein the instructions further cause the operation apparatus to cause the two or more generators to operate in proportion to respective capacities of the two or more generators, in the second operation mode.
